(19) United States
(12) Patent Application Publication
(10) Pub. No.: US 2004/0209489 A1
(43) Pub. Date: Oct. 21, 2004

(54) Apparatus for automatic docking

(76) Inventor: Edward O. Clapper, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/419,487

(22) Filed: Apr. 21, 2003

(51) Int. Cl. H01R 11/30

(52) U.S. Cl. 439/39

(57) ABSTRACT

A method and apparatus for automatic docking utilizes magnetic attraction to align and dock a mobile device with a base device. An apparatus for automatic docking comprises a mobile device and a connection interface coupled with the mobile device. The connection interface has a plurality of connectors to carry a signal, and a plurality of electromagnetic components to bring into contact and align the plurality of connectors with a base device's plurality of connectors. In addition, the plurality of electromagnetic components maintain a contact force that ensures signal integrity between the plurality of connectors and the base device's plurality of connectors.

### BACKGROUND

1. Technical Field

The invention relates to the field of device connections. More specifically, the invention relates to automatic docking of devices.

2. Description of the Related Art

For electrical connections, a minimum force between physical conductors is required to provide enough contact to ensure signal integrity. Mobile devices, such as cell phone, personal data assistants (PDAS), wireless monitors, and tablet personal computers (PCs), have a electrical connections that dock, or connect, into a base device. The base device and the mobile device transfer signals through the connections such as the following: a cell phone docks into a cradle to recharge; a PDA docks in a cradle to exchange information with another device; a tablet PC docks into a cradle or other base device to exchange signals with peripheral devices. Typically, transferring complex signals requires a greater number of connectors.

High population contacts require application of force to fully compress the connectors for a sufficient contact that will ensure a good signal between the mobile device and the base device. A large fraction of approximately one pound of force per connector is typically required to achieve a sufficient contact. Hence, an increasing number of connectors requires application of an increasing amount of force to attach sufficient contact for a good signal.

Sufficient contact for a good signal is attained in conventional mobile devices with the application of manual force (e.g., pushing the device into a base or cradle), the weight of the mobile device, and a locking mechanism. Manual force and/or the weigh of a device initially mates electrical connectors of devices. After the mating of the devices, a locking mechanism maintains the contact for signal integrity.

These locking mechanisms are inconvenient for users. As the frequency of docking and undocking increases, the inconvenience to users increases. In addition, the frequent locking and unlocking increases the risk of damage to the locking mechanism, the devices, and the connectors.

Unfortunately, the decreasing weight of mobile devices increases the need for a mechanism to maintain a sufficient contact force. The decreasing weight of mobile device becomes insufficient to maintain enough of a contact force to ensure signal integrity between a lightweight mobile devices and a base device.

Furthermore, the connectors of two devices must be aligned. Aligning the connectors often requires viewing the base device and the connectors from a difficult position. A mobile device may be docked improperly without the user realizing.

### BRIEF DESCRIPTION OF THE DRAWINGS

The invention may best be understood by referring to the following description and accompanying drawings that are used to illustrate embodiments of the invention. In the drawings:

FIG. 1 is an exemplary diagram of a system with automatic docking according to one embodiment of the invention.

FIG. 1B is an exemplary diagram illustrating increasing attraction between connection interfaces according to one embodiment of the invention.

FIG. 1C is an exemplary diagram illustrating automatic docking of connection interfaces according to one embodiment of the invention.

FIG. 2 is an exemplary diagram illustrating a connection interface with attractive material arrays as attractive material components for automatic docking according to one embodiment of the invention.

FIG. 3 is an exemplary diagram illustrating a connection interface with an attractive material ring as an attractive material component for automatic docking according to one embodiment of the invention.

FIG. 4 is an exemplary diagram illustrating a connection interface with attractive material strips placed along the connection interface for automatic docking according to one embodiment of the invention.

### DETAILED DESCRIPTION OF THE DRAWINGS

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

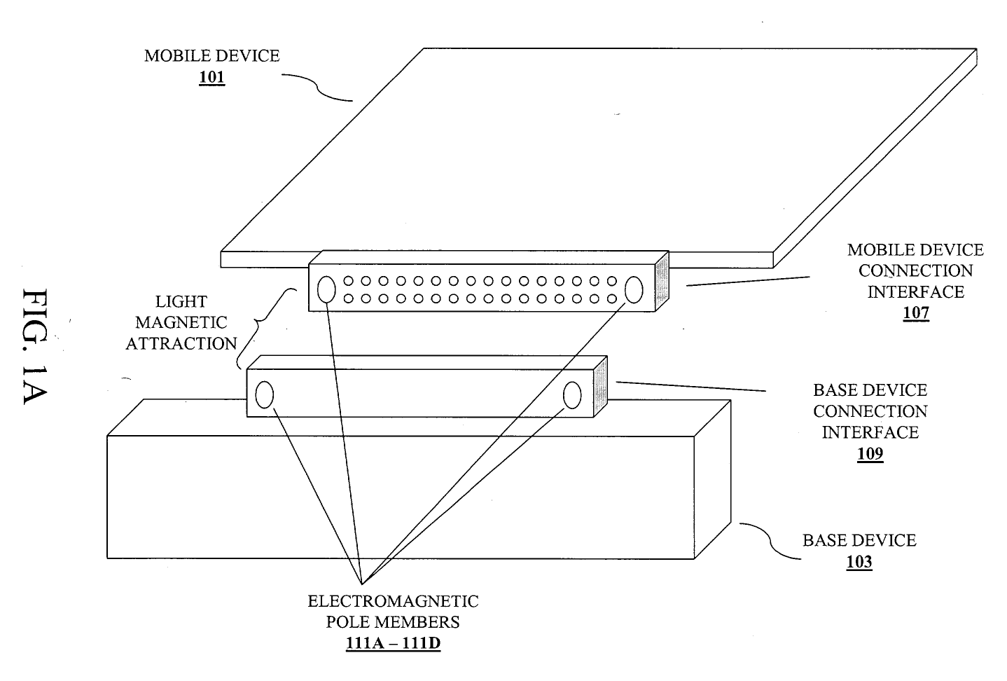

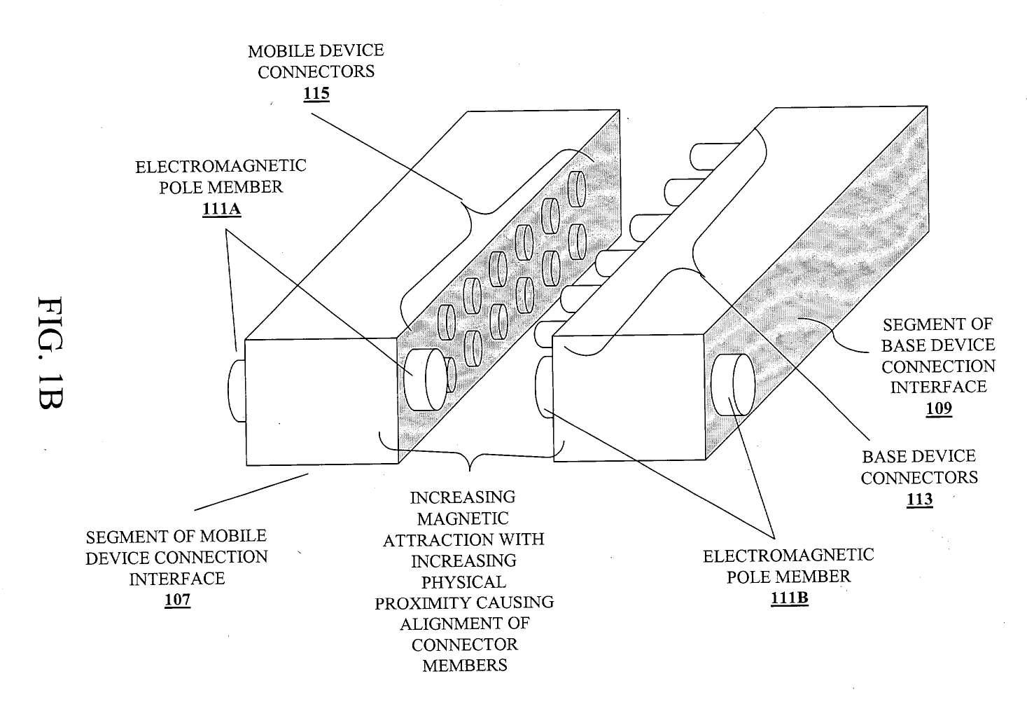

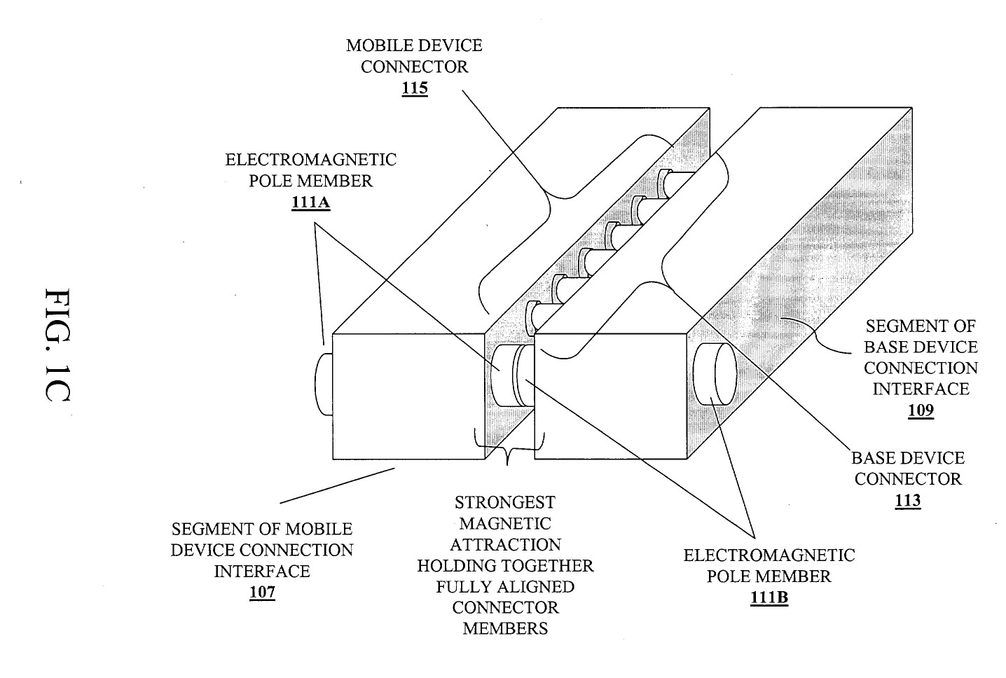

FIG. 1 is an exemplary diagram of a system with automatic docking according to one embodiment of the invention. In FIG. 1, a mobile device 101 (e.g., a cell phone, wireless monitor, tablet PC, PDA, etc.) includes a mobile device connection interface 107. FIG. 1 also illustrates a base device 103 (e.g., a cradle, charger, etc.) that includes a base device connection interface 109. The mobile device connection interface 107 carries signals to and from the mobile device 101 and the base device connection interface 109 carries signals to and from the base device 103. The signals carried by the connection interfaces 107 and 109 may be electrical, optical, both electrical and optical, etc.

The mobile device connection interface 107 includes electromagnetic pole members 111A and 111C. The base device connection interface 109 includes electromagnetic pole members 111B and 111D. The electromagnetic pole members 111A and 111C attract the electromagnetic pole members 111B and 111D. The electromagnetic pole members 111A-111D are examples of attractive material components for automatic docking. In FIG. 1, the electromagnetic pole members 111A-111D provide for a light magnetic attraction that pulls the mobile device 101 and the base device 103 together.

FIG. 1B is an exemplary diagram illustrating increasing attraction between connection interfaces according to one embodiment of the invention. FIG. 1B illustrates a segment of the base device connection interface 109 and the mobile device connection interface 107 from FIG. 1A in closer physical proximity then shown in FIG. 1A. In one embodiment of the invention, sensors, such as intermittent contact between intended connectors, detect proximity between the connection interfaces 107 and 109. When docking proximity is detected, the electromagnetic pole members 111A-111D are activated. As the physical proximity of the connection interfaces 107 and 109 increases, the magnetic attraction between the connection interfaces 107 and 109 increases. In addition to the increasing magnetic attraction, the electromagnetic pole members 111A and 111B cause the mobile device connectors 115 and the base device connectors 113 to align with each other.

FIG. 1C is an exemplary diagram illustrating automatic docking of connection interfaces according to one embodiment of the invention. In FIG. 1C, the mobile device connectors 115 and the base device connectors 113 are in full contact. The electromagnetic pole members 111A and 111B to the connection interfaces 107 and 109 together with a sufficient force to maintain contact and best ensure signal integrity. The connection interfaces 107 and 109 are at a physical proximity for the electromagnetic pole members 111A and 111B to have the strongest magnetic attraction. As the number of connectors on a device connection interface increases, the amount of force necessary to cause full contact increases for signal integrity increases.

The mobile device connection interface 107 and the base device connection interface 109 are then separated from each other by changing the attractive properties of the electromagnetic pole members. In one embodiment of the invention, the polarity of either the electromagnetic pole members 111A and 111C of the mobile device 101 or the electromagnetic pole members 111B and 111D is reversed. In another embodiment of the invention, the angle between the mobile device 101 and the base device 103 is modified to cause the attractive force between the connection interfaces 107 and 109 to decrease. Various techniques can be employed for undocking of the mobile device 101 from the base device 103 (e.g., motion detection, light sensors, infra-red, a switch to generate a current, etc.). In one embodiment of the invention, one of the connectors has a slight amount of positional flexibility. An undock event is detected when the position of the connectors changes slightly. In one embodiment of the invention, the electromagnetic pole members are shut off when an undock event occurs, whereas in other embodiments of the invention, the polarity of the electromagnetic pole members is reversed for repelling properties. Undocking the mobile device with the repelling properties of automatic docking components avoids the mobile device sticking to the base device, provides graceful undocking, etc.

The automatic docking enabled by the mechanism illustrated in FIGS. 1A-1C provides for more efficient docking and undocking, or engaging and disengaging. The connectors are lined up without the difficulties present in conventional docking systems, such as misalignment and awkward handling for a user.

The risk of damaging devices is reduced since manual pressure is not applied and locking mechanisms are not necessary. In addition, the automatic docking mechanism provides a more reliable contact force that is scalable. A device that requires a greater contact force will employ a greater number of automatic docking components are automatic docking components with greater attractive strength, regardless of the weight of the mobile device. Moreover, the power is supplied to the electromagnetic pole members from the base device in certain embodiments of the invention, thus not consuming power from the mobile device.

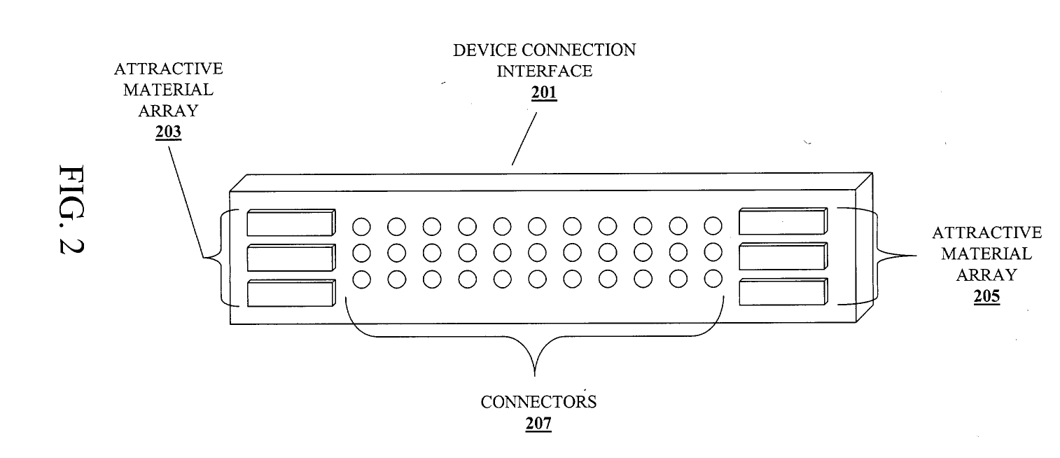

FIGS. 2-4 are exemplary diagrams illustrating various embodiments of connection interfaces having attractive material components for automatic docking. The automatic docking components are described with the term “attractive material” in FIGS. 2-4. A specific example of attractive material is magnetized material, but the described invention is not limited to magnetized material.

FIG. 2 is an exemplary diagram illustrating a connection interface with attractive material arrays as attractive material components for automatic docking according to one embodiment of the invention. A device connection interface 201 includes connectors 207, attractive material array 205, and an attractive material array 203. The attractive material arrays 203 and 205 are located at opposite ends of the connection interface. The connectors 207 are located between the attractive material arrays eO3 and 205.

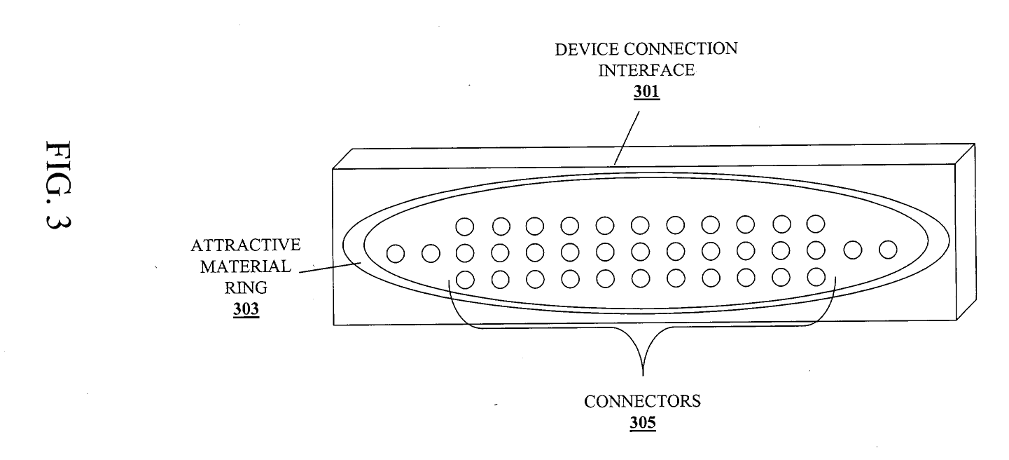

FIG. 3 is an exemplary diagram illustrating a connection interface with an attractive material ring as an attractive material component for automatic docking according to one embodiment of the invention. A device connection interface 301 includes connectors 305 and an attractive material ring 303. The attractive material ring 303 is a ring of attractive material that encircles the connectors 305.

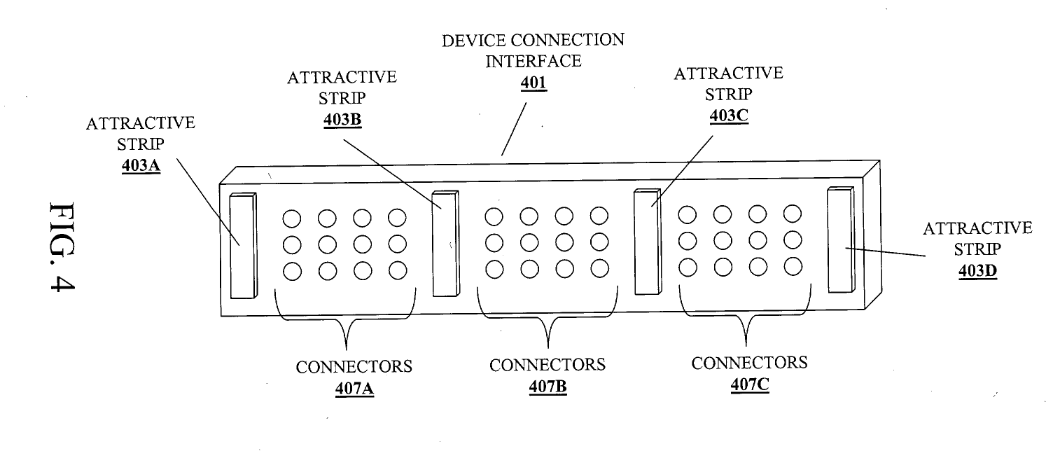

FIG. 4 is an exemplary diagram illustrating a connection interface with attractive material strips placed along the connection interface for automatic docking according to one embodiment of the invention. A device connection interface 401 includes connectors 407A-407C and attractive strips 403A-403D. The attractive strips 403A and 403D are located at opposite ends of the connection interface 401. The connectors 407A are between the attractive strip 403A and the attractive strip 403B. The connectors 407B are located between the attractive strips 403B and 403C. The connectors 407C are located between the attractive strips 403C and 403D.

While the invention has been described in terms of several embodiments, those skilled in the art will recognize that the invention is not limited to the embodiments described. The method and apparatus of the invention may be practiced with modification and alteration within the scope of the appended claims. The description is thus to be regarded as illustrative instead of limiting on the invention.

1. A method for docking a mobile device with a base device comprising:
aligning the mobile device's connection interface with the base device's connection interface using an electromagnetic force generated by a set of one or more electromagnetic poles; and
applying contact force for signal integrity between the connection interfaces with the set of electromagnetic poles.

2. The method of claim 1 further comprising reversing polarity of either the mobile device's connection interface or the base device's connection interface to undock the other device's connection interface.

3. The method of claim 1 wherein reversing polarity comprises applying a charge to electromagnetic poles of the corresponding device's connection interface.

4. A system comprising:
a mobile device including a first connection interface with a first set of one or more electromagnetic poles having a first polarity; and
a base device including a second connection interface with a second set of one or more electromagnetic poles having a second polarity that is attracted to the first polarity, the first and second sets of electromagnetic poles to generate an electromagnetic field to align the first and second connection interface.

5. The system of claim 1 further comprising a polarity reversing circuit to reverse the polarity of either the first or second set of electromagnetic poles.

6. The system of claim 4 wherein the mobile device is a cell phone, wireless monitor, tablet PC, personal data assistant, or hybrid laptop/tablet PC.

7. The system of claim 4 wherein the base device is a cradle and/or power recharger.

8. The system of claim 4 further comprising a set of one or more peripheral devices coupled with the base device.

9. The system of claim 8 wherein the set of peripheral devices includes a keyboard, mouse, and/or speakers.

10. The system of claim 8 wherein the first and second set of electromagnetic poles align with each other.

11. The system of claim 4 wherein a first and second subset of the first set of electromagnetic poles are located at opposite ends of the first connection interface.

12. The system of claim 4 wherein a first and second subset of the first set of electromagnetic poles are distributed evenly among the connectors of the first connection interface.

13. The system of claim 4 wherein the first connection interface is a pad side connection interface and the second connection interface is a pin side connection interface.

14. An apparatus comprising:
a device; and
a connection interface coupled with the device, the connection interface including,
a plurality of connectors to carry a signal, and
a magnetic alignment and contact force component to attract and align the plurality of connectors with connectors of another connection interface and to maintain a contact force that ensures signal integrity.

15. The apparatus of claim 14 wherein the device is a cell phone, tablet PC, hybrid laptop/tablet PC, personal data assistant, or wireless monitor.

16. The apparatus of claim 14 wherein the device is a cradle for a mobile device.

17. The apparatus of claim 14 wherein the connection interface is an electrical connection interface, an optical connection interface, or a hybrid electrical/optical connection interface.

18. The apparatus of claim 14 wherein the magnetic alignment and contact force component is an electromagnetic pole.

19. The apparatus of claim 18 wherein the magnetic alignment and contact force component and a second electromagnetic pole are at opposite ends of the connection interface.

20. The apparatus of claim 14 wherein the magnetic alignment and contact force component is an array of magnets.

21. The apparatus of claim 14 wherein the magnetic alignment and contact force component is one of a plurality of magnetic alignment and contact force components distributed throughout the connectors of the connection interface.

22. An apparatus comprising:
a mobile device; and
a connection interface coupled with the mobile device, the connection interface having,
a plurality of connectors to carry a signal, and
a plurality of electromagnetic components to bring into contact and align the plurality of connectors with a base device's plurality of connectors and to maintain a contact force that ensures signal integrity between the plurality of connectors and the base device's plurality of connectors.

23. The apparatus of claim 22 wherein the mobile device is a cell phone, tablet PC, hybrid laptop/tablet PC, personal data assistant, or wireless monitor.

24. The apparatus of claim 22 further comprising a disengage component that reverses polarity of the plurality of electromagnetic components when activated.

25. The apparatus of claim 22 wherein the plurality of connectors carry electrical signals or optical signals.

26. The method of claim 1, further comprising:
activating the electromagnetic poles once the base device's connection interface comes into contact with the mobile device's connection interface.
